(19) United States
(12) Patent Application Publication
(10) Pub. No.: US 2025/0112376 A1
(43) Pub. Date: Apr. 3, 2025

(54) TRANSMISSION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Yusuke ISONO, Nisshin-city (JP); Masakazu IKEDA, Nisshin-city (JP); Takahiro KATO, Nisshin-shi (JP)

(21) Appl. No.: 18/792,702

(22) Filed: Aug. 2, 2024

(30) Foreign Application Priority Data
Sep. 28, 2023 (JP) 2023-168654

(51) Int. Cl. H01Q 13/02

(52) U.S. Cl. CPC H01Q 13/02

(57) ABSTRACT

A transmission device for transmitting an electromagnetic wave includes a first transmission member having a first transmission path and a second transmission member having a second transmission path. The first transmission path is a passage that has an opening on one surface of the first transmission member. The first transmission member and the second transmission member are disposed in such a manner that the second transmission path faces the one surface of the first transmission member with a gap between the second transmission member and the one surface of the first transmission member. The first transmission member has at least one recessed portion that has an opening at a location away from the first transmission path on the one surface.

### CROSS REFERENCE TO RELATED APPLICATION

The present application claims the benefit of priority from Japanese Patent Application No. 2023-168654 filed on Sep. 28, 2023. The entire disclosure of the above application is incorporated herein by reference.

### TECHNICAL FIELD

The present disclosure relates to a transmission device.

### BACKGROUND

In a transmission device that transmits an electromagnetic wave between an integrated circuit (IC) board, an antenna, and the like, a waveguide in which a transmission path is formed is coupled to a substrate and the like.

### SUMMARY

The present disclosure provides a transmission device for transmitting an electromagnetic wave, and the transmission device includes a first transmission member having a first transmission path and a second transmission member having a second transmission path. The first transmission path is a passage that has an opening on one surface of the first transmission member. The first transmission member and the second transmission member are disposed in such a manner that the second transmission path faces the one surface of the first transmission member with a gap between the second transmission member and the one surface of the first transmission member. The first transmission member has at least one recessed portion that has an opening at a location away from the first transmission path on the one surface.

### BRIEF DESCRIPTION OF DRAWINGS

Objects, features and advantages of the present disclosure will become apparent from the following detailed description made with reference to the accompanying drawings. In the drawings:

FIG. 1 is a perspective view of a transmission device according to a first embodiment;

FIG. 2 is a cross-sectional view of the transmission device according to the first embodiment;

FIG. 3 is a top view of a first transmission member;

FIG. 4 is a diagram for explaining reduction of the leakage electric field by a recessed portion;

FIG. 5 is a diagram for explaining reduction of the leakage electric field by a recessed portion;

FIG. 6 is a diagram showing the distribution of the leakage electric field;

FIG. 7 is a diagram showing a relationship between a position in a longitudinal direction of a first transmission path and the electric field;

FIG. 8 is a diagram showing a relationship between a width of a recessed portion and a transmission loss;

FIG. 9 is a diagram showing a relationship between a depth of a recessed portion and a transmission loss;

FIG. 10 is a diagram showing a difference between equiphase surfaces of the leakage electric field and a shape of the recessed portion when an opening of the recessed portion has a linear shape;

FIG. 11 is a diagram showing curvatures of the equiphase surfaces of the leakage electric field;

FIG. 12 is a diagram for comparing shapes of the equiphase surfaces of the leakage electric field and concentric circles centered on the center of the first transmission path;

FIG. 13 is a diagram showing a state in which the centers of the concentric circles in FIG. 12 are offset;

FIG. 14 is a diagram showing a state in which the center of the recessed portion is offset to the opposite side of the recessed portion with respect to the first transmission path;

FIG. 15 is a diagram for comparing the shapes of equiphase surfaces of the leakage electric field and ellipses centered on the center of the first transmission path;

FIG. 16 is a diagram showing a relationship between a central angle of the recessed portion and the transmission loss;

FIG. 17 is a diagram showing a relationship between a frequency of an electromagnetic wave and the transmission loss;

FIG. 18 is a top view of a first transmission member according to a second embodiment;

FIG. 19 is a cross-sectional view of a transmission device according to a third embodiment;

FIG. 20 is a cross-sectional view of a transmission device according to a fourth embodiment;

FIG. 21 is a cross-sectional view of a transmission device according to a fifth embodiment;

FIG. 22 is a cross-sectional view of a transmission device according to a sixth embodiment;

FIG. 23 is a top view of a first transmission member according to another embodiment;

FIG. 24 is a top view of a first transmission member according to another embodiment;

FIG. 25 is a top view of a first transmission member according to another embodiment;

FIG. 26 is a top view of a first transmission member according to another embodiment;

FIG. 27 is a top view of a first transmission member according to another embodiment;

FIG. 28 is a top view of a first transmission member according to another embodiment; and

FIG. 29 is a cross-sectional view of a transmission device according to another embodiment.

### DETAILED DESCRIPTION

In a transmission device configured by coupling a waveguide and a substrate, if a gap is generated between the substrate and the waveguide due to warping that occurs during the manufacture of the substrate, there is a possibility that a transmission loss increases due to a leakage electric field from the gap. The leakage electric field can be reduced, for example, by providing a periodic structure around the waveguide, and making members around the waveguide function as metamaterials.

However, according to diligent studies by the present inventors, it was found that in a transmission device having the above structure, a transmission loss that affects radar characteristics occurs in high frequency bands such as 77 GHz used in millimeter wave radars and the like.

A transmission device for transmitting an electromagnetic wave according to an aspect of the present disclosure includes a first transmission member having a first transmission path and a second transmission member having a second transmission path is formed. The first transmission path is a passage that has an opening on one surface of the first transmission member. The first transmission member and the second transmission member are disposed in such a manner that the second transmission path faces the one surface of the first transmission member with a gap between the second transmission member and the one surface of the first transmission member. The first transmission member has at least one recessed portion that has an opening at a location away from the first transmission path on the one surface.

According to the above-described configuration, the leakage electric field from the gap between the first transmission member and the second transmission member is cancelled by a reflected electric field from the at least one recessed portion, and the transmission loss can be reduced.

Hereinafter, embodiments of the present disclosure will be described with reference to the drawings. In the following embodiments, the same or equivalent parts are denoted by the same reference numerals.

### First Embodiment

The following describes a first embodiment. A transmission device according to the present embodiment transmits an electromagnetic wave, and is used, for example, to transmit the electromagnetic wave between an antenna of an on-vehicle radar and an IC board.

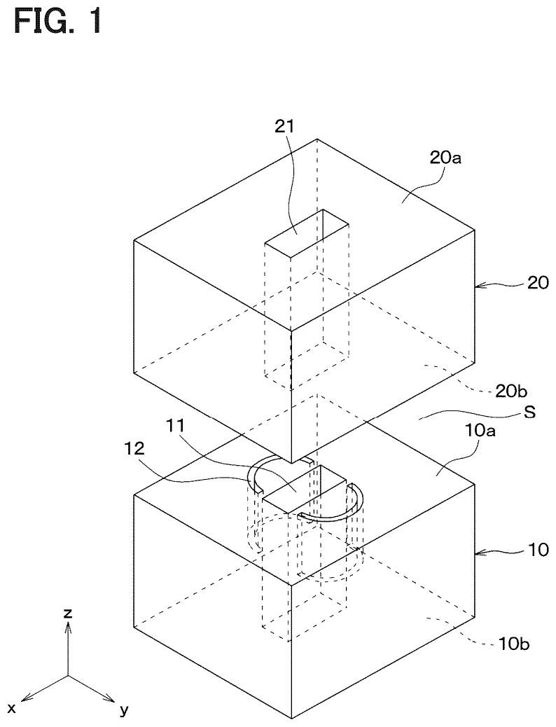

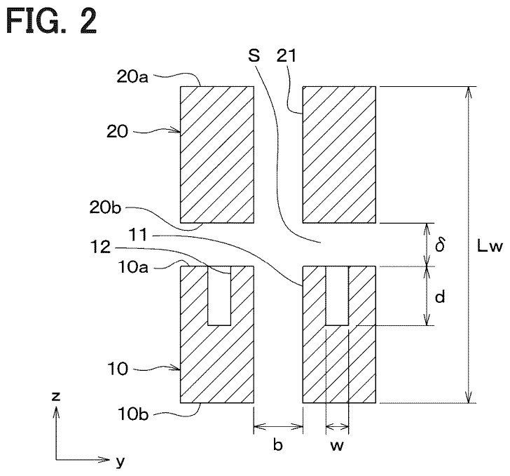

As shown in FIG. 1 and FIG. 2, the transmission device includes a first transmission member 10 and a second transmission member 20. The first transmission member 10 and the second transmission member 20 are formed as waveguides. The first transmission member 10 has a first transmission path 11 formed therein, and the second transmission member 20 has a second transmission path 21 formed therein.

The first transmission member 10 is a rectangular prism-shaped metal member having a first surface 10a and a second surface 10b opposite to the first surface 10a. The first surface 10a corresponds to one surface of the first transmission member 10. Two directions parallel to the first surface 10a and perpendicular to each other are defined as an x-axis direction and a y-axis direction, respectively, and a direction perpendicular to both the x-axis direction and the y-axis direction, that is, the normal direction to the first surface 10a, is defined as a z-axis direction. The first transmission path 11 extends in the z-axis direction, has openings on the first surface 10a and the second surface 10b, and serves as a passage connecting the first surface 10a and the second surface 10b.

The second transmission member 20 is a rectangular prism-shaped metal member having a first surface 20a and a second surface 20b opposite to the first surface 20a. The second transmission member 20 is disposed such that the first surface 20a and the second surface 20b are parallel to the first surface 10a and the second surface 10b. The second transmission path 21 extends in the z-axis direction, has openings on the first surface 20a and the second surface 20b, and serves as a passage connecting the first surface 20a and the second surface 20b.

The first transmission member 10 and the second transmission member 20 are connected such that the opening of the first transmission path 11 on the first surface 10a faces the opening of the second transmission path 21 on the second surface 20b. However, a gap S is provided between the first transmission member 10 and the second transmission member 20. The gap S is generated, for example, by warping of the first transmission member 10 or the second transmission member 20.

The shapes of the openings on the first surface 10a and the second surface 10b of the first transmission path 11 and the shapes of the openings on the first surface 20a and the second surface 20b of the second transmission path 21 are configured to transmit electromagnetic waves in a frequency band in a fundamental mode. The fundamental mode is a mode with the lowest cutoff frequency among the electromagnetic wave distribution patterns in the first transmission member 10 and the second transmission member 20, and is, for example, the TE01 mode.

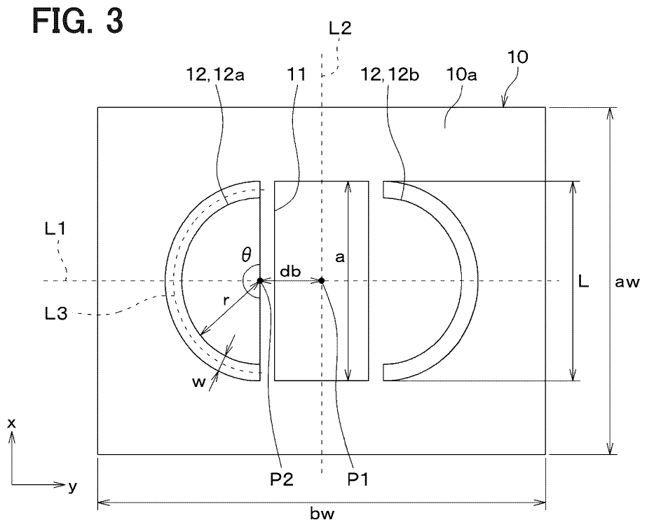

Specifically, the shape of the openings of the first transmission path 11 is a shape having a longitudinal direction (that is, a long-side direction) and a lateral direction (that is, a short-side direction) that are parallel to the first surface 10a and perpendicular to each other. In the present embodiment, the shape of the openings of the first transmission path 11 is a rectangle with the x-axis direction as the longitudinal direction and the y-axis direction as the lateral direction. As shown in FIG. 3, a center of the rectangle forming the opening of the first transmission path 11 in an xy plane is denoted by P1. The shape of the openings of the second transmission path 21 is a rectangle with the x-axis direction as the longitudinal direction and the y-axis direction as the lateral direction.

A cross section of the first transmission path 11 parallel to the xy plane has the same shape as the openings on the first surface 10a and the second surface 10b. A cross section of the second transmission path 21 parallel to the xy plane has the same shape as the openings on the first surface 20a and the second surface 20b.

The first transmission member 10 has recessed portions 12. The recessed portions 12 open at locations away from the first transmission path 11 on the first surface 10a. The recessed portions 12 are formed to reduce the leakage electric field from the gap S.

The recessed portions 12 are respectively formed on both sides of the first transmission path 11 in the y-axis direction. As shown in FIG. 3, the recessed portions 12 formed on one side and the other side in the y-axis direction with respect to the first transmission path 11 are referred to as a recessed portion 12a and a recessed portion 12b, respectively. The recessed portions 12a and 12b are each shaped to be line-symmetrical with respect to a straight line L1 that passes through the center P1 and is parallel to the y-axis direction. The recessed portions 12a and 12b are arranged symmetrically with respect to a straight line L2 that passes through the center P1 and is parallel to the x-direction.

Each of the recessed portions 12a and 12b is shaped as an arc on the first surface 10a. The arc that forms the opening of each of the recessed portions 12a and 12b is denoted by L3, and a center of the arc L3 is denoted by P2. The center P2 is located at a position different from the center P1 on the straight line L1.

As shown in FIG. 2 and FIG. 3, widths of the first transmission path 11 in the x-axis direction and the y-axis direction are denoted by a and b, respectively. A width of the recessed portion 12 in the x-axis direction is denoted by L. A width of the recessed portion 12 in a direction perpendicular to both the arc L3 and the z-axis direction is denoted by w. A depth of the recessed portion 12 in the z-axis direction is denoted by d. The width w and depth d are designed to be greater than a predetermined value and constant throughout the recessed portion 12, but may vary due to processing precision, and corners of the recessed portion 12 may be rounded. A distance between the center P1 and the center P2 is denoted by db. A radius of the arc L3 is denoted by r. A central angle of the arc L3 is denoted by θ. A width of the gap S in the z-axis direction is denoted by δ. A length in the z-axis direction from the second surface 10b to the first surface 20a is denoted by Lw. Widths of the first transmission member 10 in the x-axis direction and the y-axis direction are denoted by aw and bw, respectively. Widths of the second transmission member 20 in the x-axis direction and the y-axis directions are the same as those of the first transmission member 10. Widths of the second transmission path 21 in the x-axis direction and the y-axis directions are the same as those of the first transmission path 11.

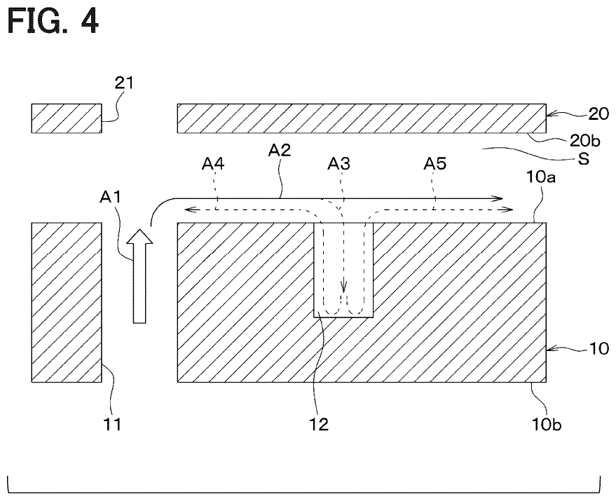

The principle of how the recessed portion 12 reduces the leakage electric field will be described. When the electromagnetic wave is transmitted as indicated by an arrow A1 in FIG. 4, an electric field leaks and spreads from the first transmission path 11 through the gap S to the outside of the transmission device as indicated by an arrow A2. However, a part of the electric field enters the inside of the recessed portion 12 as indicated by an arrow A3 and is reflected at a bottom of the recessed portion 12. A part of the electric field reflected by the recessed portion 12 returns to the first transmission path 11 as indicated by an arrow A4, and the other part travels toward the outside of the transmission device as indicated by an arrow A5.

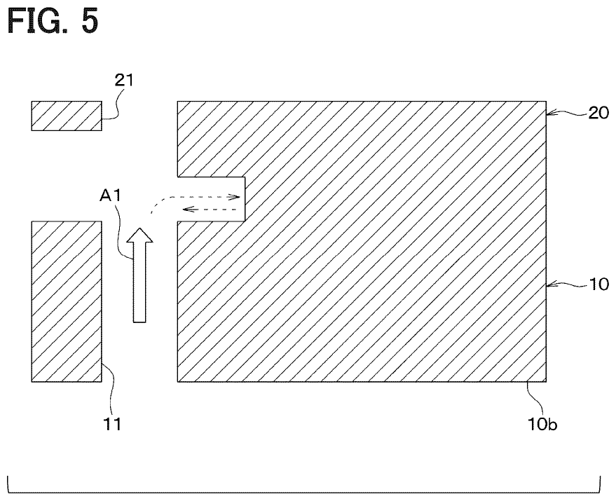

By appropriately setting the width and the depth of the recessed portion 12, the leakage electric field indicated by the arrow A2 and the reflected electric field indicated by the arrow A4 resonate between the first transmission path 11 and the recessed portion 12. Moreover, in a portion across the recessed portion 12 from the first transmission path 11, the leakage electric field indicated by the arrow A2 and the reflected electric field indicated by the arrow A5 cancel each other out. This results in an electric field distribution similar to that in which the gap S is closed by a wall and a recessed portion is formed in the wall, as shown in FIG. 5. In this manner, the leakage electric field from the gap S can be reduced.

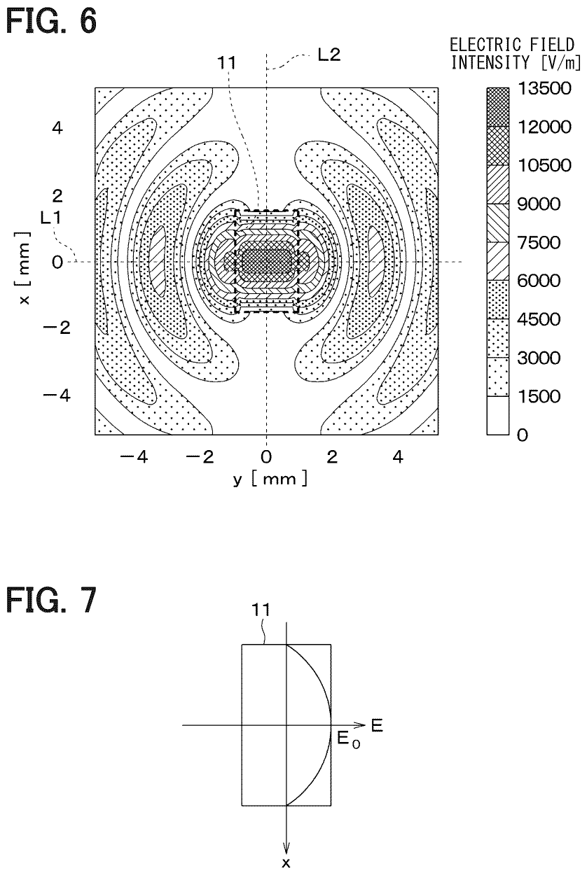

As shown in FIG. 6, the leakage electric field from the first transmission path 11 is distributed such that equiphase surfaces spread out concentrically from the centers of the two long sides of the rectangle that constitutes the opening of the first transmission path 11. This leakage electric field has a maximum value on the straight line L1 and a minimum value on the straight line L2. Therefore, by setting a<L so that peripheries of the long sides of the rectangle are covered by the recessed portions 12 and arranging the recessed portions 12 on both sides with respect to the first transmission path 11 in the y-axis direction, the leakage electric field can be efficiently reduced.

When the electric field inside the first transmission path 11 is E, the electric field E has a maximum value E₀ at the center in the x-axis direction as shown in FIG. 7. The electric field E has a distribution symmetrical with respect to the straight line L1, and becomes smaller toward both ends of the first transmission path 11 in the x-axis direction. In consideration of such an electric field distribution, it is desirable to set the width L so that the shape of the recessed portion 12 is symmetrical with respect to the straight line L1. It is preferable that the width L is set so as to cover at least half of the leakage electric field.

A method of estimating the leakage electric field from the electric field distribution in the first transmission path 11 and setting the arrangement ranges of the recessed portions 12 will be described. The electric field intensity E of the TE01 mode is expressed by the following mathematical formula 1 according to Maxwell's equations.

$$E = {E}_{0} sin \frac{π x}{a} \qquad [ Mathematical Formula 1 ]$$

Therefore, the total power Aₜₒₜₐₗ in the transmission device is expressed by the following mathematical formula 2.

$$\begin{matrix}{A}_{total} ∝ {\int }_{0}^{a} {E}^{2} dx \\ = \frac{a {E}_{0}^{2}}{2}\end{matrix} \qquad [ Mathematical Formula 2 ]$$

A power A_{L} in a range of width L symmetrical with respect to the straight line L1 is expressed by the following mathematical formula 3.

$$\begin{matrix}{A}_{L} ∝ {\int }_{\frac{a}{2} - L / 2}^{\frac{a}{2} + L / 2} {E}^{2} dx \\ = \frac{a {E}_{0}^{2}}{2} ( L + \frac{a}{π} sin ( \frac{π L}{a} ) )\end{matrix} \qquad [ Mathematical Formula 3 ]$$

In the vicinity of the first transmission path 11, it can be considered that the width L prevents leakage of a radio wave of only power A_{L} out of the total power Aₜₒₜₐₗ and the remaining power passes through the coupling portion. Thus, a transmission loss Aₗₒₛₛ can be expressed by the following mathematical formula 4.

$$\begin{matrix}{A}_{l o s s} = \frac{{A}_{L}}{{A}_{t o t a l}} \\ = \frac{L}{a} + \frac{1}{π} sin ( \frac{π L}{a} )\end{matrix} \qquad [ Mathematical Formula 4 ]$$

That is, the transmission loss Aₗₒₛₛ changes depending on the ratio L/a of the width a to the width L.

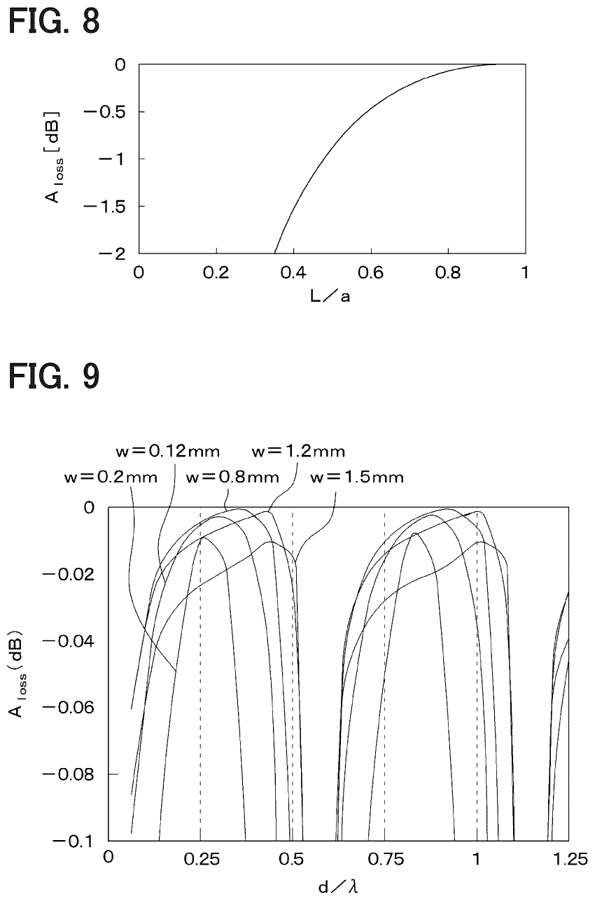

FIG. 8 shows theoretical values of the transmission loss Aₗₒₛₛ when L/a is changed. From FIG. 8, it can be seen that, for example, in order to make the transmission loss Aₗₒₛₛ less than −0.1 dB, it is necessary to make L/a=0.75 or larger, that is, to set the width L larger than 75% of the width a. For example, when the first transmission member 10 is configured with a WR-12 waveguide, since a=3.1 mm, and the width L of the recessed portion 12 must be 2.325 mm or larger.

The width w and depth d of the recessed portion 12 will now be described. A wavelength of the electromagnetic wave transmitted through the first transmission path 11 is denoted by λ, and a frequency of the electromagnetic wave is denoted by f. The transmission loss of the transmission device is denoted by Aₗₒₛₛ. The present inventors performed a simulation with f=76.5 GHz and changed the width w and depth d to examine the transmission loss Aₗₒₛₛ. FIG. 9 shows the analysis results of the simulation. FIG. 9 shows the analysis results in the range from d=0 to d/λ=1.25, that is, d=1.25λ≈5 mm. FIG. 9 also shows the analysis results when w=0.2 mm, 0.12 mm, 0.8 mm, 1.2 mm, and 1.5 mm, that is, when w=0.051λ, 0.1275λ, 0.204λ, 0.306λ, and 0.3825λ.

When N is an integer equal to or greater than 0, as shown in FIG. 9, the transmission loss Aₗₒₛₛ is small when the depth d is approximately λ/4+N·λ/2. Furthermore, when the depth d is N·λ/2, the transmission loss Aₗₒₛₛ becomes large. This is reasonable in principle due to the periodic nature of electromagnetic waves. However, since increasing the width w slightly improves performance, the transmission loss Aₗₒₛₛ is not necessarily minimized when d=λ/4+N·λ/2. Considering the width w, the transmission loss Aₗₒₛₛ can be reduced by setting the depth d to be equal to or greater than λ/4+N·λ/2 and equal to or less than (N+1)λ/2. The depth d may be outside this range. For example, when it is desired to minimize the structure due to processing constraints, d=0.2λ or d≈0.2λ may be adopted.

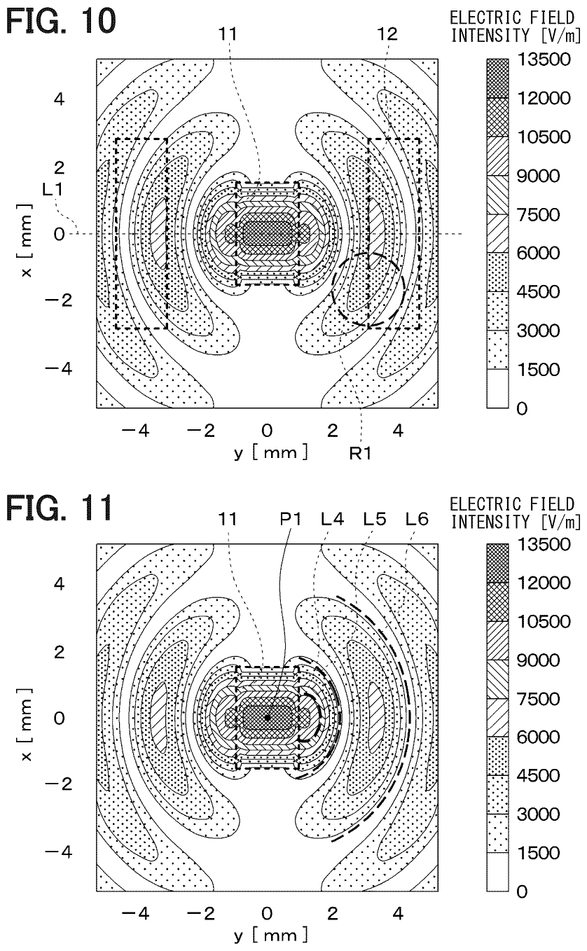

The shape of the openings of the recessed portions 12 will be described. For the distribution of the leakage electric field described above, if the recessed portions 12 are extended in straight lines parallel to the x-direction as shown in FIG. 10, for example, angles between the equiphase surfaces of the electric field and the extension direction of the recessed portions 12 become large in locations away from the straight line L1, such as in a region R1. Accordingly, the phase of the reflected electric field and the phase at which the leakage electric field can be efficiently cancelled may be largely shifted, the leakage electric field restriction performance may be deteriorated.

In contrast, by forming the openings of the recessed portions 12 in the arc shapes as in the present embodiment, the openings of the recessed portions 12 conform to the electric field distribution, and the leakage electric field restriction performance can be improved.

The curvature of the arc L3 will now be described. It is desirable to set the curvature of the arc L3 so as to conform to a distribution shape of an equal power of the leakage electric field. Here, the equal power is synonymous with equiphase when material and spatial attenuation are not taken into consideration. The equiphase surfaces of the leakage electric field have large curvature in the vicinity of the first transmission path 11 due to the influence of the corners and straight edges of the first transmission path 11, as shown by dashed lines L4, L5, and L6 in FIG. 11. The curvatures of the equiphase surfaces decrease with increasing distance from the first transmission path 11, and converge to a perfect circle centered on the center P1. It is desirable to set the curvatures of the recessed portions 12 taking this into consideration.

For example, when the transmission device is housed in an integrated circuit such as a radar, it is desirable for mounting purposes to reduce the size of the transmission device, so that the recessed portions 12 are disposed near the long sides of the first transmission path 11. In this case, it is desirable to increase the curvature of the arc L3. On the other hand, when the recessed portions 12 are formed at locations far away from the first transmission path 11, it is desirable to make the curvature of the arc L3 small.

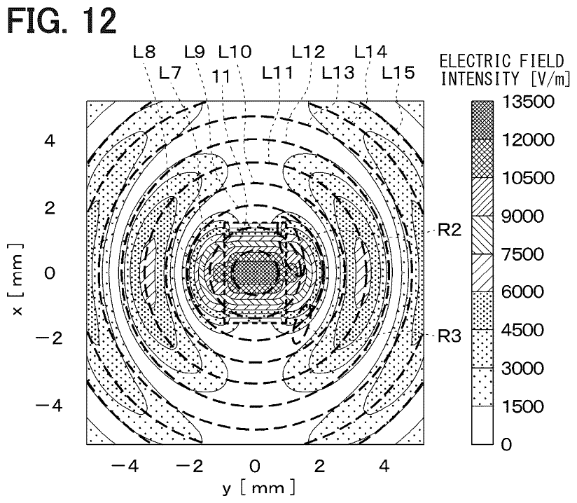

The position of the center P2 will be described. Dashed lines L7 to L15 in FIG. 12 are concentric circles centered on the center P1. In the vicinity of the first transmission path 11, the difference in shape between the equiphase surfaces of the leakage electric field and the concentric circles becomes large. Thus, when the center P2 is aligned with the center P1, the difference between the equiphase surfaces of the leakage electric field and the shapes of the recessed portions 12 become large, and the leakage electric field restriction performance will be deteriorated. For example, in FIG. 12, the difference between the shapes of the equiphase surfaces and the shapes of the recessed portions 12 is large in a region R2 in the vicinity of the first transmission path 11 and in a region R3 farther from the first transmission path 11 and the straight line L1 than the region R2.

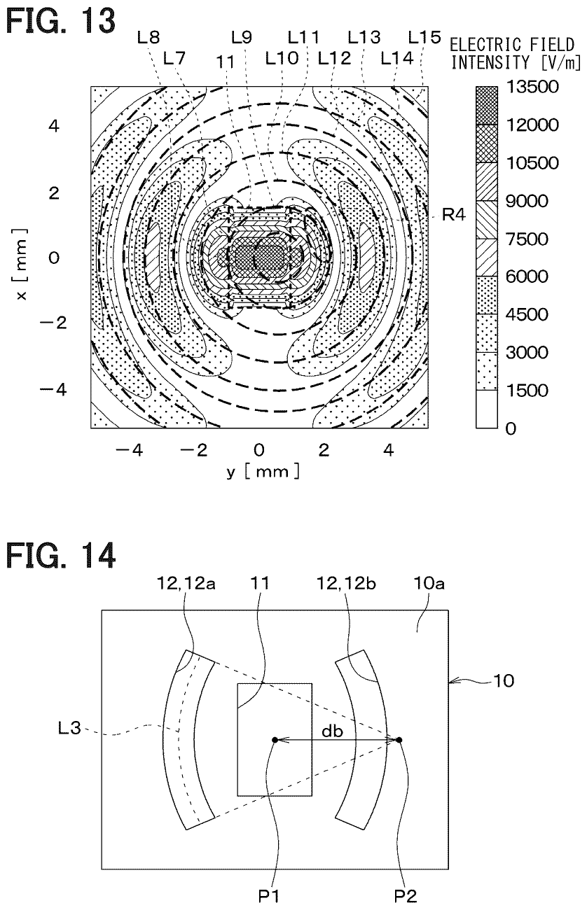

On the other hand, when the center of the concentric circles is moved in the y-axis direction from the center P1 as shown in FIG. 13, the difference in shape between the equiphase surfaces of the electric field and the concentric circles becomes smaller. FIG. 13 shows the electric field distribution when the first transmission member 10 is configured with an EIA standard WR-12 waveguide and the recessed portions 12 are formed by offsetting the center P2 from the center P1 by 0.6 mm in the y-axis direction. For example, in FIG. 13, in a region R4 away from the straight line L1, the difference between the equiphase surfaces and the shapes of the recessed portions 12 is small. In this way, by placing the center P2 at a position different from the center P1, the difference between the equiphase surfaces of the leakage electric field and the shapes of the recessed portions 12 becomes smaller, and the leakage electric field restriction performance can be further improved.

Furthermore, if the distance db between the center P1 and the center P2 is too large, the recessed portions 12 will not be shaped to cover the corners of the first transmission path 11, which may result in a decrease in the leakage electric field restriction performance. Therefore, it is desirable to make the distance db somewhat small. For example, when the first transmission member 10 is formed of a WR-12 waveguide and the frequency f is 60 GHz to 90 GHZ, it is desirable to set the distance db to 0.6 mm to 1.0 mm, that is, within ±0.2 mm in the y-axis direction with respect to the centers of the long sides of the first transmission path 11.

However, this is not the case when the center P2 is offset from the center P1 in a direction opposite to the recessed portion 12. That is, as shown in FIG. 14, when the center P2 of the arc L3 of the recessed portion 12a is placed on the same side as the recessed portion 12b with respect to the first transmission path 11, the distance db can be made large. For example, when the first transmission member 10 is formed of the WR-12 waveguide as described above, the distance db can be made greater than 1.0 mm.

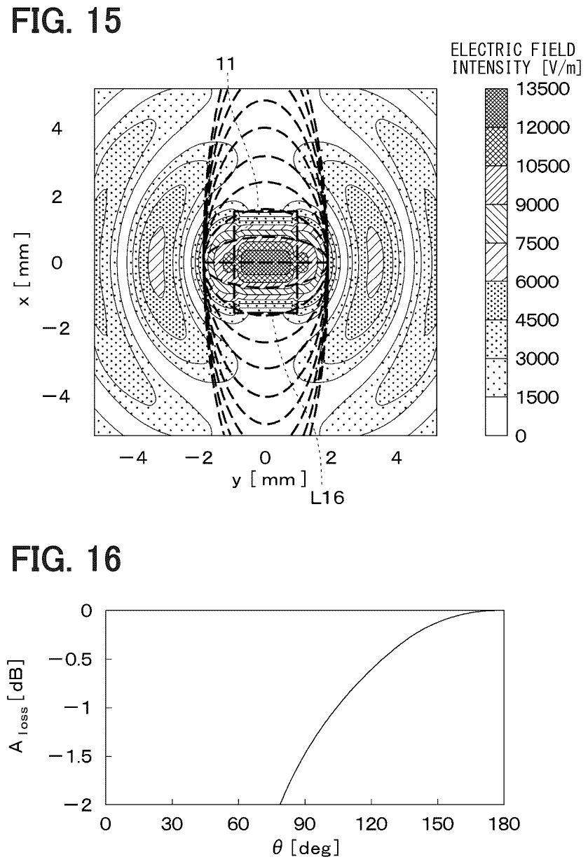

Furthermore, even when the center P2 is aligned with the center P1, by making the openings of the recessed portions 12 elliptical arcs, the recessed portions 12 can be shaped to conform to the equiphase surfaces of the leakage electric field, and the leakage electric field restriction performance can be further improved. For example, in FIG. 15, multiple ellipses having different lengths of axes in the x-axis direction and centered on the center P1 are indicated by dashed lines. By forming the recessed portions 12 along the ellipse indicated by the dashed line L16 among the multiple ellipses, the openings of the recessed portions 12 can be made to be shapes that conform to the equiphase surfaces of the leakage electric field.

FIG. 16 shows the relationship between the central angle θ and the transmission loss Aₗₒₛₛ when the center P2 is offset onto the long side of the first transmission path 11 and the radius r is set to a/2. It can be seen from FIG. 16 that, for example, in order to make the transmission loss Aₗₒₛₛ less than −0.1 dB, the central angle θ needs to be approximately 150° or more.

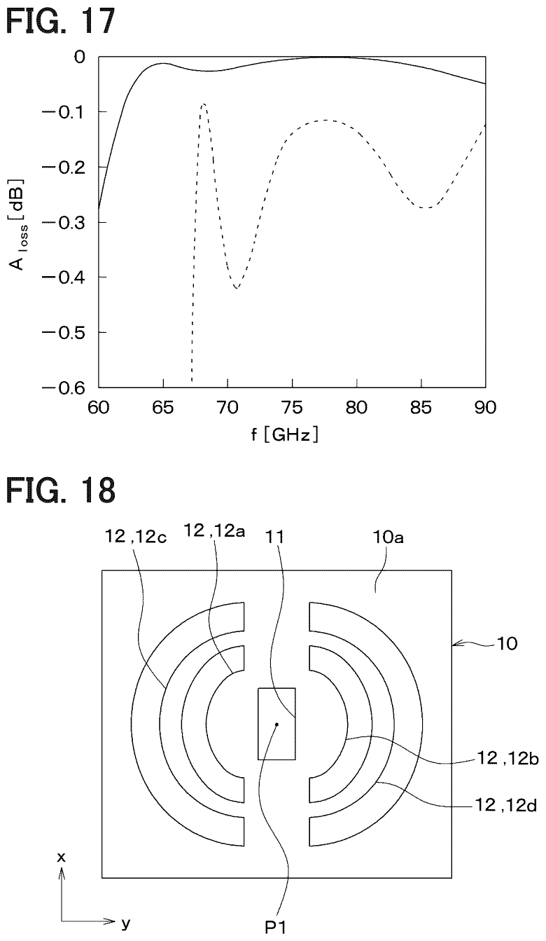

FIG. 17 shows the results of a simulation conducted by the present inventors to examine the relationship between the frequency f and the transmission loss Aₗₒₛₛ. In this simulation, the dimensions of the first transmission member 10 and the second transmission member 20 were set such that Lw=7 mm, aw=6 mm, bw=6 mm, a=3.1 mm, b=1.55 mm, δ=0.1 mm, d=1.4 mm, w=0.8 mm, r=1.55 mm, θ=150°, and db=0.8 mm. A solid line and a dashed line in FIG. 17 are simulation results when the openings of the recessed portions 12 are formed into arc shapes and linear shapes, respectively.

As shown in FIG. 17, in the high frequency band used in millimeter wave radars, specifically, in the range of 65 GHz to 90 GHz, the transmission loss Aₗₒₛₛ could be reduced to less than 0.1 dB. Moreover, in the case where the openings of the recessed portions 12 have the arc shapes, the transmission loss Aₗₒₛₛ could be reduced more than in the case where the openings of the recessed portions 12 have the linear shapes.

As described above, in the present embodiment, the first transmission member 10 has the recessed portions 12 that open to the locations on the first surface 10a away from the first transmission path 11, so that the leakage electric field from the gap S is canceled out by the reflected electric field from the recessed portions 12, thereby reducing the transmission loss. For example, when an electromagnetic wave is transmitted between a substrate and an antenna by the transmission device of the present embodiment, the power of the substrate can be supplied to the antenna with low loss.

Furthermore, in the present embodiment, the transmission loss can be reduced simply by forming the recessed portions 12 in the first transmission member 10, and complicated processing of the first transmission member 10 is not required. Thus, it is easy to manufacture the transmission device. In addition, an increase in the size of the first transmission member 10 can be restricted.

According to the above embodiment, the following effects can be obtained.

The first transmission path 11 is configured to transmit the electromagnetic wave in the fundamental mode. This enables highly efficient electromagnetic wave transmission in the fundamental mode.

The recessed portions 12 have shapes extending along the equiphase surfaces of the electric field spreading from the first transmission path 11 as the center. Accordingly, it is possible to efficiently cancel out the leakage electric field.

The recessed portions 12 are respectively formed on both sides of the first transmission path 11. Accordingly, it is possible to cancel out the leakage electric field to a greater extent than when the recessed portion 12 is formed only on one side of the first transmission path 11.

The depth d is set to be equal to or greater than λ/4+N·λ/2 and equal to or less than (N+1)λ/2. Accordingly, the leakage electric field can be efficiently cancelled by the reflected electric field from the recessed portions 12. For example, when the depth d is set to λ/4+N·λ/2, the time required to form the recessed portions 12 can be shortened and the leakage electric field can be efficiently cancelled.

The opening of the first transmission path 11 on the first surface 10a has the longitudinal direction and the lateral direction which are perpendicular to each other, and the shapes of the openings of the recessed portions 12 on the first surface 10a are symmetrical with respect to the straight line L1 which passes through the center P1 and is parallel to the lateral direction. Accordingly, the difference between the equiphase surfaces of the leakage electric field and the shapes of the recessed portions 12 can be reduced. Therefore, the leakage electric field restriction performance can be further improved.

The openings of the recessed portions 12 on the first surface 10a are shaped as the arcs. Accordingly, the recessed portions 12 can have shapes that conform to the distribution of the leakage electric field, and the leakage electric field restriction performance can be improved.

The opening of the first transmission path 11 on the first surface 10a has the longitudinal direction and the lateral direction which are perpendicular to each other, and the center P2 of the arc L3 is located on the straight line L1 which passes through the center P1 and is parallel to the lateral direction. By positioning the center P2 in this manner and setting the width L so that the shape of the recessed portion 12 is linearly symmetrical with respect to the straight line L1, the difference between the equiphase surfaces of the leakage electric field and the shapes of the recessed portions 12 is reduced. Therefore, the leakage electric field restriction performance can be further improved.

The center P2 is located at a different position from the center P1. Accordingly, the difference between the equiphase surfaces of the leakage electric field and the shapes of the recessed portions 12 can be reduced. Therefore, the leakage electric field restriction performance can be further improved.

### Second Embodiment

The following describes a second embodiment of the present disclosure. The present embodiment is different from the first embodiment in the number of the recessed portions 12, and the other configurations are the same as in the first embodiment, so only the difference from the first embodiment will be described.

In the present embodiment, a plurality of recessed portions 12 is formed on each of one side and the other side with respect to the first transmission path 11 in the y-axis direction. The recessed portions 12 formed on the one side with respect to the first transmission path 11 in the y-axis direction have widths in the x-axis direction that increase with increase in distances from the center P1 to the respective recessed portions 12. Similarly, the recessed portions 12 formed on the other side with respect to the first transmission path 11 in the y-axis direction have widths in the x-axis direction that increase with increase in distances from the center P1 to the respective recessed portions 12.

Specifically, as shown in FIG. 18, the recessed portions 12 formed on the one side with respect to the first transmission path 11 in the y-axis direction include a recessed portion 12a and a recessed portion 12c that opens at a location farther away from the first transmission path 11 than the recessed portion 12a. Furthermore, the recessed portions 12 formed on the other side with respect to the first transmission path 11 in the y-axis direction include a recessed portion 12b and a recessed portion 12d that opens at a location farther away from the first transmission path 11 than the recessed portion 12b. That is, two recessed portions 12 are formed on each side with respect to the first transmission path 11 in the y-axis direction.

The recessed portion 12c has a width in the x-axis direction greater than that of the recessed portion 12a, and opens in an arc shape so as to cover the recessed portion 12a from the one side in the y-axis direction. The recessed portion 12d has a width in the x-axis direction greater than that of the recessed portion 12b, and opens in an arc shape so as to cover the recessed portion 12b from the other side in the y-axis direction.

The present embodiment can achieve the same effects as those of the first embodiment from the same configuration and operation as those of the first embodiment.

According to the embodiment described above, it is possible to achieve the following advantageous effects.

The plurality of recessed portions 12 is formed on one side with respect to the first transmission path 11, and among the plurality of recessed portions 12, the widths of the recessed portions 12 increase with increase in distances from the center P1 to the respective recessed portions 12. Accordingly, it is possible to cover the electric field spreading concentrically, and efficiently reduce the leakage electric field.

### Third Embodiment

The following describes a third embodiment of the present disclosure. In the present embodiment, the configuration of the second transmission member 20 is changed from that of the first embodiment, and the remaining configurations are the same as those of the first embodiment, and therefore, only portions different from the first embodiment will be described.

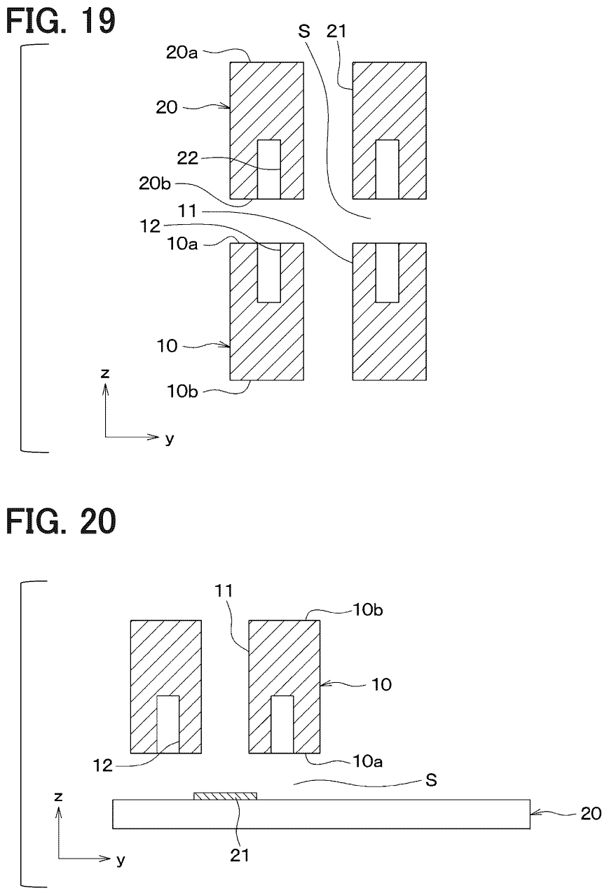

As shown in FIG. 19, the second transmission member 20 of the present embodiment has recessed portions 22. The recessed portions 22 have structures similar to the recessed portions 12. The recessed portions 22 are formed on both sides with respect to the second transmission path 21 in the y-axis direction, one on each side, and open in an arc shape at a location on the second surface 20b away from the second transmission path 21. The two recessed portions 22 are shaped to be line-symmetric with respect to a line that passes through the center of the second transmission path 21 and is parallel to the y-axis direction. The two recessed portions 22 are arranged symmetrically with respect to a line that passes through the center of the second transmission path 21 and is parallel to the x-axis direction.

By forming the recessed portions 22 in the second transmission member 20, the leakage electric field from the gap S is cancelled by the reflected electric field at the recessed portions 22, so that the transmission loss can be further reduced.

In the present embodiment, it is possible to attain the advantageous effects as similar to the effects in the first embodiment with the configuration and operation identical to the ones in the first embodiment.

### Fourth Embodiment

The following describes a fourth embodiment. In the present embodiment, the configuration of the second transmission member 20 is changed from that of the first embodiment, and the remaining configurations are the same as those of the first embodiment, and therefore, only portions different from the first embodiment will be described.

As shown in FIG. 20, the second transmission member 20 of the present embodiment is formed of a substrate. The substrate is a dielectric substrate on which a radio frequency (RF) circuit is formed, which is used in wireless devices such as radar and communication devices. The second transmission path 21 is a microstrip line formed on the substrate. Note that, as architectures of wireless device RF circuits, there are ball grid array (BGA), a launcher in package (LiP) and the like, and the present embodiment is applicable to any of them.

The present embodiment can achieve the same effects as those of the first embodiment from the same configuration and operation as those of the first embodiment.

### Fifth Embodiment

The following describes a fifth embodiment. In the present embodiment, the configuration of the second transmission member 20 is changed from that of the first embodiment, and the remaining configurations are the same as those of the first embodiment, and therefore, only portions different from the first embodiment will be described.

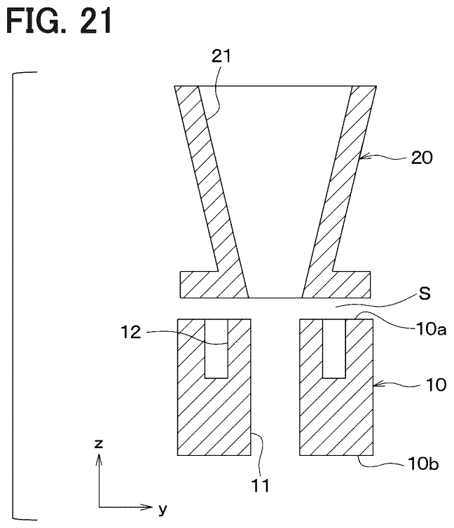

As shown in FIG. 21, the second transmission member 20 of the present embodiment is an antenna. For example, the second transmission member 20 is a horn antenna, and a passage formed inside the second transmission member 20 and having a truncated pyramid shape serves as the second transmission path 21.

In the present embodiment, it is possible to achieve the advantageous effects as similar to the effects in the first embodiment with the configuration and operation identical to the ones in the first embodiment.

### Sixth Embodiment

The following describes a sixth embodiment. In the present embodiment, the configuration of the first transmission member 10 is changed from that of the first embodiment, and the remaining configurations are the same as those of the first embodiment, and therefore, only portions different from the first embodiment will be described.

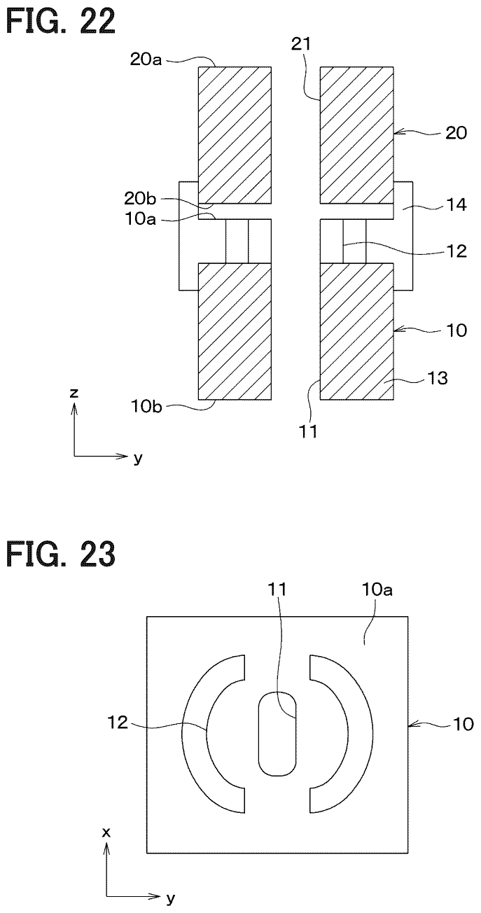

As shown in FIG. 22, the first transmission member 10 of the present embodiment includes a main body portion 13 having a rectangular prism shape and a connection portion 14 connected to the second transmission member 20, and the recessed portions 12 are formed in the connection portion 14. In the present embodiment, a surface of the connection portion 14 that faces the second transmission member 20 is designated as a first surface 10a, and the first transmission path 11 includes a portion that penetrates the main body portion 13 and a portion that penetrates the connection portion 14.

In FIG. 22, the recessed portions 12 penetrate the connection portion 14 and bottom surfaces of the recessed portions 12 are formed by a surface of the main body portion 13. However, the recessed portions 12 may be formed to a depth that reaches halfway through the connection portion 14.

Even in a case where a portion of the surface of the main body portion 13 facing the second transmission member 20, away from the first transmission path 11, is made flat, the leakage electric field can be reduced by attaching the connection portion 14 having the recessed portions 12 formed therein.

In the present embodiment, it is possible to attain the advantageous effects as similar to the effects in the first embodiment with the configuration and operation identical to the ones in the first embodiment.

### Other Embodiments

It should be noted that the present disclosure is not limited to the embodiments described above, and can be modified as appropriate. Individual elements or features of a particular embodiment are generally not limited to that particular embodiment, but, where applicable, are interchangeable and can be used in a selected embodiment, even if not specifically shown or described. In each of the above-described embodiments, individual elements or features of a particular embodiment are not necessarily essential unless it is specifically stated that the elements or the features are essential, or unless the elements or the features are obviously essential in principle. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the above embodiments, when the shape of an element or the positional relationship between elements is mentioned, the present disclosure is not limited to the specific shape or positional relationship unless otherwise particularly specified or unless the present disclosure is limited to the specific shape or positional relationship in principle.

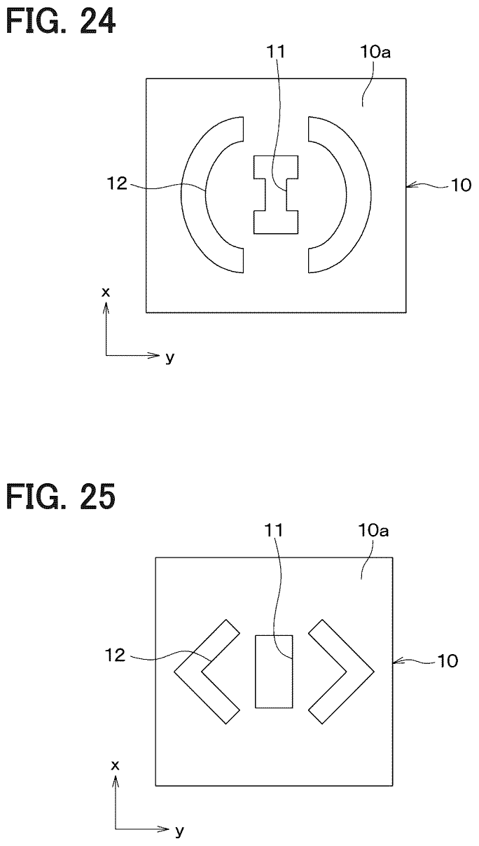

The shape of the opening of the first transmission path 11 may be different from that in the first embodiment. For example, as shown in FIG. 23, the shape of the opening of the first transmission path 11 may be a rectangle with rounded corners. In another example, as shown in FIG. 24, the shape of the opening of the first transmission path 11 may be an H-shape composed of a rectangle extending in the x-direction and a rectangle extending from both ends of the rectangle on both sides in the y-direction. Furthermore, the shape of the opening of the second transmission path 21 may be different from that in the first embodiment. For example, the shape of the opening of the second transmission path 21 may be the same as the shape of the opening of the first transmission path 11 shown in FIG. 23 or FIG. 24.

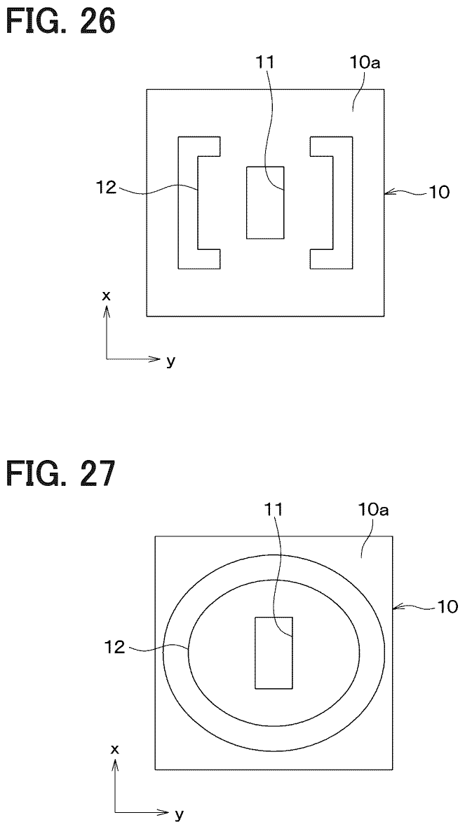

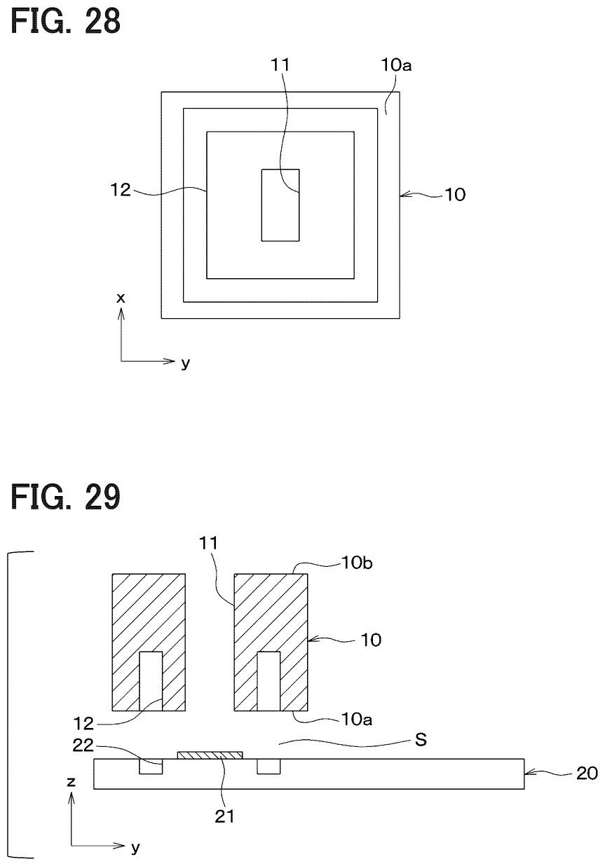

The shape of the openings of the recessed portions 12 may be different from that in the first embodiment. For example, the shape of the openings of the recessed portions 12 may be linear. Even when the shape of the openings of the recessed portions 12 is linear, by appropriately setting the width w, the depth d, the width L, and the like, it is possible to reduce the transmission loss Aₗₒₛₛ to less than 0.1 dB, as compared to the result shown in FIG. 17. As shown in FIG. 25, the openings of the recessed portions 12 may be L-shaped. As shown in FIG. 26, the openings of the recessed portions 12 may be U-shaped. In another example, end portions of the openings of the recessed portions 12 may be bent. In another example, end portions of the openings of the recessed portions 12 may be formed with protruding portions and recessed portions. In another example, end portions of the two recessed portions 12 may be connected to each other. For example, as shown in FIG. 27, the opening of the recessed portion 12 may have a circumferential shape. As shown in FIG. 28, the opening of the recessed portion 12 may have a rectangular frame shape.

The recessed portion 12 may be formed only on one side with respect to the first transmission path 11 in the y-axis direction. In the second embodiment, the two recessed portions 12 are formed on both sides with respect to the first transmission path 11. However, three or more recessed portions 12 may be formed on both sides or one side with respect to the first transmission path 11.

In the third to sixth embodiments, similarly to the second embodiment, a plurality of recessed portions 12 may be formed on both sides with respect to the first transmission path 11. As shown in FIG. 29, in the fourth embodiment, the recessed portions 22 may be formed in the same manner as in the third embodiment. In the fifth and sixth embodiments, the recessed portion 22 may be formed in the same manner as in the third embodiment. In the sixth embodiment, the second transmission member 20 may be a substrate, similarly to the fourth embodiment. In the sixth embodiment, the second transmission member 20 may be an antenna, similarly to the fifth embodiment.

What is claimed is:

1. A transmission device for transmitting an electromagnetic wave, comprising:
a first transmission member having a first transmission path; and
a second transmission member having a second transmission path, wherein
the first transmission path is a passage that has an opening on one surface of the first transmission member,
the first transmission member and the second transmission member are disposed in such a manner that the second transmission path faces the one surface of the first transmission member with a gap between the second transmission member and the one surface of the first transmission member, and
the first transmission member has at least one recessed portion that has an opening at a location away from the first transmission path on the one surface.

2. The transmission device according to claim 1, wherein
the first transmission path is configured to transmit the electromagnetic wave in a fundamental mode.

3. The transmission device according to claim 1, wherein
the at least one recessed portion has a shape extending along equiphase surfaces of an electric field spreading from the first transmission path as a center.

4. The transmission device according to claim 1, wherein
the at least one recessed portion includes two recessed portions respectively disposed on both sides with respect to the first transmission path.

5. The transmission device according to claim 1, wherein
the at least one recessed portion includes a plurality of recessed portions disposed on one side with respect to the first transmission path, and
a width of each of the plurality of recessed portions is increased with increase in a distance from a center of the first transmission path to each of the plurality of recessed portions.

6. The transmission device according to claim 1, wherein
the opening of the at least one recessed portion has a predetermined width on the one surface.

7. The transmission device according to claim 1, wherein
the at least one recessed portion has a predetermined depth in a normal direction of the one surface.

8. The transmission device according to claim 1, wherein
a depth of the at least one recessed portion is set to be equal to or greater than λ/4+N·λ/2 and equal to or less than (N+1)λ/2, where λ is a wavelength of the electromagnetic wave transmitted by the first transmission path, and N is an integer equal to or greater than 0.

9. The transmission device according to claim 8, wherein
the depth of the at least one recessed portion is set to λ/4+N·λ/2.

10. The transmission device according to claim 1, wherein
the opening of the first transmission path has a shape having a longitudinal direction and a lateral direction that are perpendicular to each other, and
the opening of the at least one recessed portion has a shape that is symmetrical with respect to a straight line that passes through a center of the opening of the first transmission path and is parallel to the lateral direction.

11. The transmission device according to claim 1, wherein
the opening of the at least one recessed portion is shaped as an arc.

12. The transmission device according to claim 11, wherein
the opening of the first transmission path has a shape having a longitudinal direction and a lateral direction that are perpendicular to each other, and
the arc that forms the opening of the at least one recessed portion has a center on a straight line that passes through a center of the opening of the first transmission path and is parallel to the lateral direction.

13. The transmission device according to claim 12, wherein
the center of the arc that forms the opening of the at least one recessed portion is located at a position different from the center of the opening of the first transmission path.
